(19) United States
(12) Patent Application Publication
(10) Pub. No.: US 2021/0114900 A1
(43) Pub. Date: Apr. 22, 2021

(54) METHOD OF STERILIZING BALLAST WATER AND DEVICE THEREOF

(71) Applicant: Poseidon Energy Tech CO., Ltd, Hsinchu City (TW)

(72) Inventor: TSUNG-YU CHEN, Tainan City (TW)

(21) Appl. No.: 16/656,660

(22) Filed: Oct. 18, 2019

(51) Int. Cl. C02F 1/48

(52) U.S. Cl. CPC C02F 1/482; C02F 2103/008

(57) ABSTRACT

A method of sterilizing ballast water contains providing a device in a pressurized cabin of a ship, the device includes: a first sterilization unit, multiple second sterilization units, and a third sterilization unit. The first sterilizer includes a first valve connected with a first pump via at least one first pipe, and the multiple second sterilization units are soaked in ballast water of the pressurized cabin. A method of sterilizing the ballast water contains steps of: S1. feeding seawater into the first valve from an exterior of the ship and pumping the seawater into the first sterilizer via the at least one first pipe; S2. magnetizing, wherein the first sterilizer has multiple magnetization elements so as to destroy cell walls of microorganism and bacteria in the seawater by using a magnetic field of the multiple magnetization elements; and S3. inhibiting a growth of the microorganism and the bacteria.

### FIELD OF THE INVENTION

The present invention relates to a method of sterilizing ballast water and a device thereof which are capable of reducing a cost of silver ion or antimicrobial agents and destroying cell walls of microorganism and bacteria in ballast water.

### BACKGROUND OF THE INVENTION

When the ship arrives at the destination and unloads the cargo, the vessel loses its load and causes the vessel to rise above the level, causing the hull to shake. To overcome such a problem, Ballast Water Management Convention (BWM Convention) is set by International Maritime Organization (IMO) in 2004 so that the hulls are kept balanced by ways of ballast water. Ballast is material that is used to provide stability to a vehicle or structure. Ballast, other than cargo, may be placed in a vehicle, often a ship or the gondola of a balloon or airship, to provide stability. A compartment within a boat, ship, submarine, or other floating structure that holds water is called a ballast tank. Water should move in and out from the ballast tank to balance the ship. In a vessel that travels on the water, the ballast will remain below the water level, to counteract the effects of weight above the water level. The ballast may be redistributed in the vessel or disposed of altogether to change its effects on the movement of the vessel.

In general, the ballast water volume of a ship is about 30%-40% of its load. Depending on the design, size and strength of the ship, a cargo ship with a load of 100,000 tons, for example, is up to ballast water. When the ship enters the port to load cargo, it will discharge the ballast water inhaled, and a large amount of ballast water carries a large number of unknown aquatic lives. It is also brought to the sea near the unloading port with the ship from all over the world, which may cause serious biological pollution problems.

The problems caused by modern shipping ballast water, such as the outbreak of cholera in three different port cities in Peru in 1991, are the tragedy that caused the improper management of the ballast water discharge from ships and caused thousands of deaths. An epidemic was spread to South American countries. It was only gradually eliminated in 1994, but a total of nearly 10,000 people died of cholera. The disaster was very heavy.

Another merchant ship sailing in the Asia-Pacific region was at the end of the 20th century in Hong Kong and the coastal ports of mainland China. The red tide bacteria were released due to the discharge of ballast water, which caused fisheries in Hong Kong and mainland China to reach nearly 10 million US dollars. Cases such as severe losses are extremely harmful to life or the environment.

In recent decades, ballast water has become a major issue in international efforts to reduce pollution from ships. Traditional ballast water treatment includes filtration, pharmaceutical, catalytic, deoxygenation, ionization, ozone treatment or Ultraviolet irradiation and other methods to treat ballast water, wherein the over-cracking method is used to remove small insects and plankton in ballast water; the pharmaceutical method uses a ferric acid or the like as a water purifying agent to eliminate the small amount remaining in the seawater. Microorganisms; catalysis, deoxygenation, ionization, ozone treatment or ultraviolet radiation each cause organisms to die by different mechanisms; traditional treatment systems usually need to include a Filter Unit, a UV Unit, and an Operation Control Panel (Operation and Systems such as Control Panel, Piping System, and Electric System are complex, and because of the high cost of chemicals, the general ballast water system costs about $3 million to $1 million, and subsequent maintenance costs. And the cost of consumables is also the point of cost considerations, and every major international port in Taiwan has many different countries every year. All kinds of merchant ships enter and leave, a large number of ballast water carrying a large number of unknown aquatic organisms are also brought from all over the world and discharged in the waters near the ports. The problems that may be caused by the people and relevant units are closely watched and actively guarded.

At present, more than 53 countries in the world signed the D-2 Ship Ballast Water Management Convention in October 2016. The signatory of the International Ships Ballast Water and Sediment Management Convention (BWM Convention) has reached 52 countries, accounting for 35.14 of the total tonnage of merchant ships. %, meeting the conditions for entry into force, the Convention came into effect on Sep. 8, 2017, while Table 1 below specifies the performance standards for ballast water in D-2, and the performance standards for ballast water treatment are specified in Annex D-2 of the BWM Convention. Allowable concentrations of living organisms and indicator microorganisms.

TABLE 1
D-2 performance standard table of Barrel water

| Biological | Survivable | | |
|---|---|---|---|
| species | organism size | concentration | inspection specification |
| All kinds | ≥50 μm | <10/m³ | none |
| | ≥10 μm, <50 μm | <10/m³ | Method of detecting |
| | | | Marine zooplankton |
| | | | (Environmental |
| | | | inspection office |
| | | | E701.20C) |
| Vibrio | — | <1 CFU/100 mL | Inspection of food |
| cholerae | | or 1 g | microorganisms Vibrio |
| (O1 & | | | cholerae (Food and |
| O139) | | | Drug Administration) |
| E. coli | — | <250 CFU/ | Method of testing |
| | | 100 mL or 1 g | E. coli in water |
| | | | (Environmental |
| | | | inspection office |
| | | | E235.52C) |
| Enterococci | — | <100 CFU/ | Method of testing |
| | | 100 mL or 1 g | Enterococcus in water |
| | | | (Environmental |
| | | | inspection office |
| | | | E235.51C) |

Remarks: CFU is a colony forming unit (colony-forming unit)

The present invention has arisen to mitigate and/or obviate the afore-described disadvantages.

### SUMMARY OF THE INVENTION

The primary aspect of the present invention is to provide a method of sterilizing ballast water and a device thereof which are capable of reducing a cost of silver ion or antimicrobial agents and destroying cell walls of microorganism and bacteria in ballast water.

To obtain the above aspect, a method of sterilizing ballast water provided by the present invention contains providing a device mounted in a pressurized cabin of a ship, the device includes: a first sterilization unit, multiple second sterilization units, and a third sterilization unit, wherein the first sterilizer includes a first valve connected with a first pump via at least one first pipe, the first sterilizer is connected with a first end of the first pump, and the at least one first pipe is connected with a second end of the first pump, and the multiple second sterilization units are accommodated in the pressurized cabin and are soaked in ballast water of the pressurized cabin.

A method of sterilizing the ballast water provided by the present invention steps of:

S1. feeding seawater, wherein the seawater is fed into the first valve from an exterior of the ship, and the first pump pumps the seawater into the first sterilizer via the at least one first pipe;

S2. magnetizing, wherein the first sterilizer has multiple magnetization elements so that after the seawater flows into the first sterilizer, a magnetic field of the multiple magnetization elements destroy cell walls of microorganism and bacteria in the seawater, and the seawater is fed into the pressurized cabin so as to produce the ballast water; and

S3. inhibiting a growth of the microorganism and the bacteria, wherein when the ballast water contacts with the multiple second sterilization units of the pressurized cabin, the multiple second sterilization units release silver ion or antimicrobial agents so as to inhibit a growth of the microorganism and the bacteria in the ballast water, wherein an amount of the silver ion or the antimicrobial agents is reduced after the Step S2.

### BRIEF DESCRIPTION OF THE DRAWINGS

FIG. 1 is a schematic view showing the assembly of a device of sterilizing ballast water according to a preferred embodiment of the present invention.

FIG. 2 is a flow chart of a method of sterilizing ballast water according to a preferred embodiment of the present invention.

FIG. 3 is a schematic view showing the assembly of a part of the device of sterilizing the ballast water according to the preferred embodiment of the present invention.

FIG. 4 is a cross sectional view showing the assembly of a part of the device of sterilizing the ballast water according to the preferred embodiment of the present invention.

FIG. 4 is a cross sectional view showing the operation of a part of a device of sterilizing ballast water according to another preferred embodiment of the present invention.

### DETAILED DESCRIPTION OF THE PREFERRED EMBODIMENTS

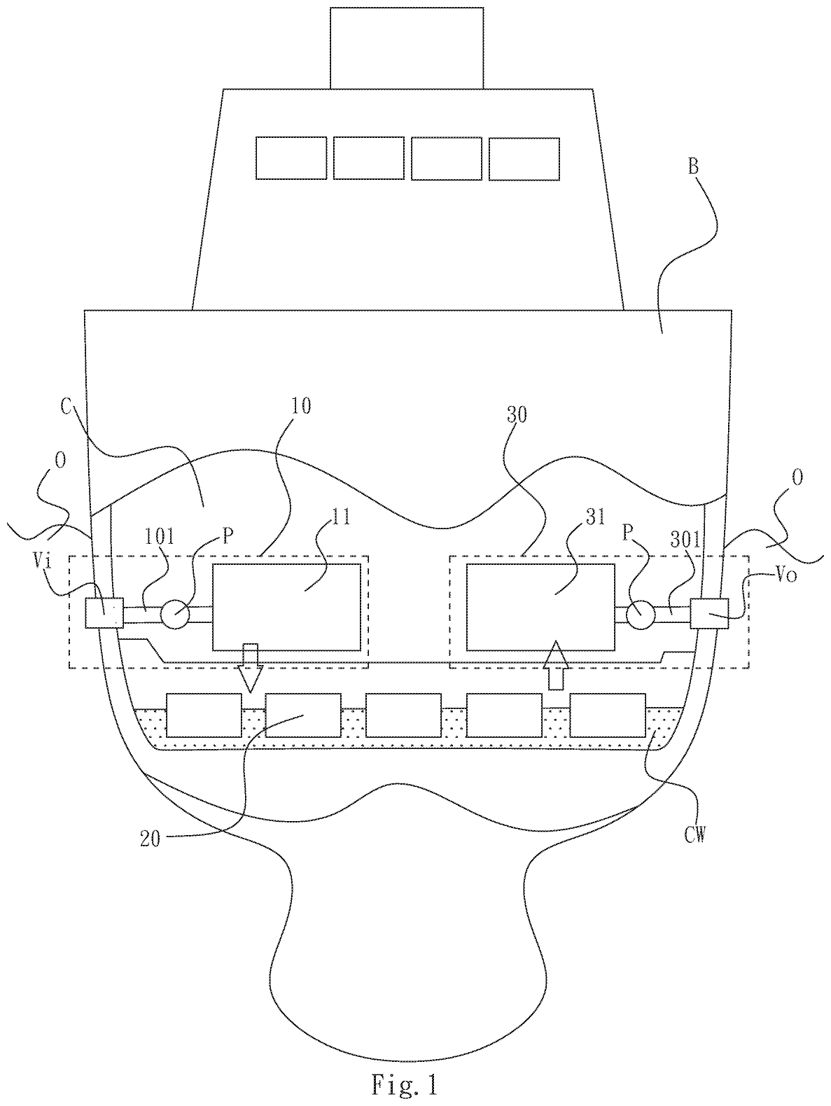

With reference to FIG. 1, a device of sterilizing ballast water of a preferred embodiment of the present invention is designed according to Section D-2 of Ballast Water Management (BWM) Convention and is mounted in a pressurized cabin C of a ship B, the device comprises: a first sterilization unit 10, multiple second sterilization units 20, and a third sterilization unit 30.

The first sterilizer 10 includes a first valve Vi configured to guide seawater O into the ship B, a first pump P connected with the first valve Vi via at least one first pipe 101 and configured to pump the seawater O into a first sterilizer 11, wherein the first sterilizer 11 is connected with a first end of the first pump P, and the at least one first pipe 101 is connected with a second end of the first pump P, such that the seawater O flows into the pressurized cabin C to produce ballast water CW.

The multiple second sterilization units 20 are accommodated in the pressurized cabin C and are soaked in the ballast water CW of the pressurized cabin C.

The third sterilization unit 30 is mounted in a predetermined position of the ship B and includes a second pump P configured to pump the ballast water CW out of a second valve Vo from the pressurized cabin C via a second sterilizer 31 and a second pipe 301, wherein the second sterilizer 31 is connected with a first end of the second pump P, and the second pipe 301 is connected with a second end of the second pump P.

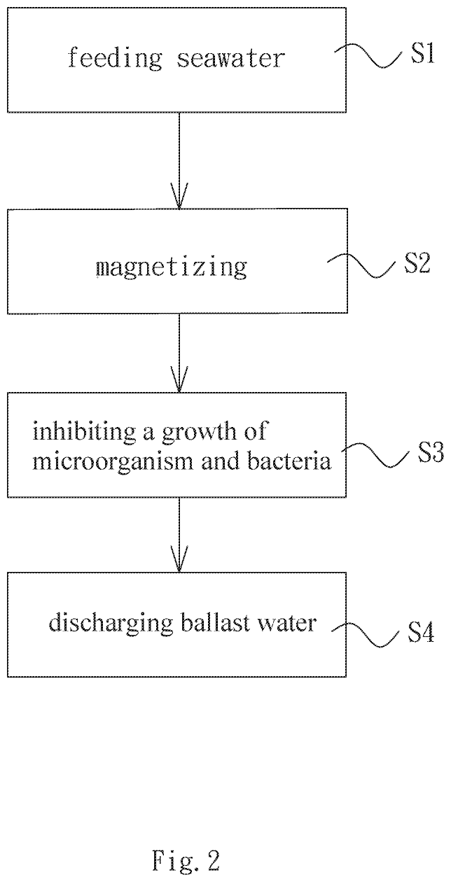

Referring to FIG. 2, a method of sterilizing the ballast water according the preferred embodiment of the present invention comprises steps of:

S1. feeding the seawater O, wherein the seawater O is fed into the first valve Vi from an exterior of the ship B, and the first pump P pumps the seawater O into the first sterilizer 11 via the at least one first pipe 101, wherein the first sterilizer 11 is connected with the first end of the first pump P, and the at least one first pipe 101 is connected with the second end of the first pump P;

S2. magnetizing, wherein the first sterilizer 11 has multiple magnetization elements so that after the seawater O flows into the first sterilizer 11, the magnetic field of the multiple magnetization elements destroy cell walls of microorganism and bacteria in the seawater O, and the seawater O is fed into the pressurized cabin C to produce the ballast water CW;

S3. inhibiting a growth of the microorganism and the bacteria, wherein when the ballast water CW contacts with the multiple second sterilization units 20 of the pressurized cabin C, the multiple second sterilization units 20 release sterilizing substances (such as silver ion or antimicrobial agents) so as to inhibit the growth of the microorganism and the bacteria, wherein an amount of the silver ion or the antimicrobial agents is reduced after the Step S2; and

S4. discharging the ballast water CW, wherein the ballast water CW is pumped out of the pressurized cabin C by the second pump P via the second sterilizer 31, the second sterilizer 31 has multiple magnetization elements so as to produce a magnetic file to destroy the cell walls of rest microorganism and bacteria in the ballast water CW, and the second pump P further pumps the ballast water CW out of the second valve Vo via the second pipe 301.

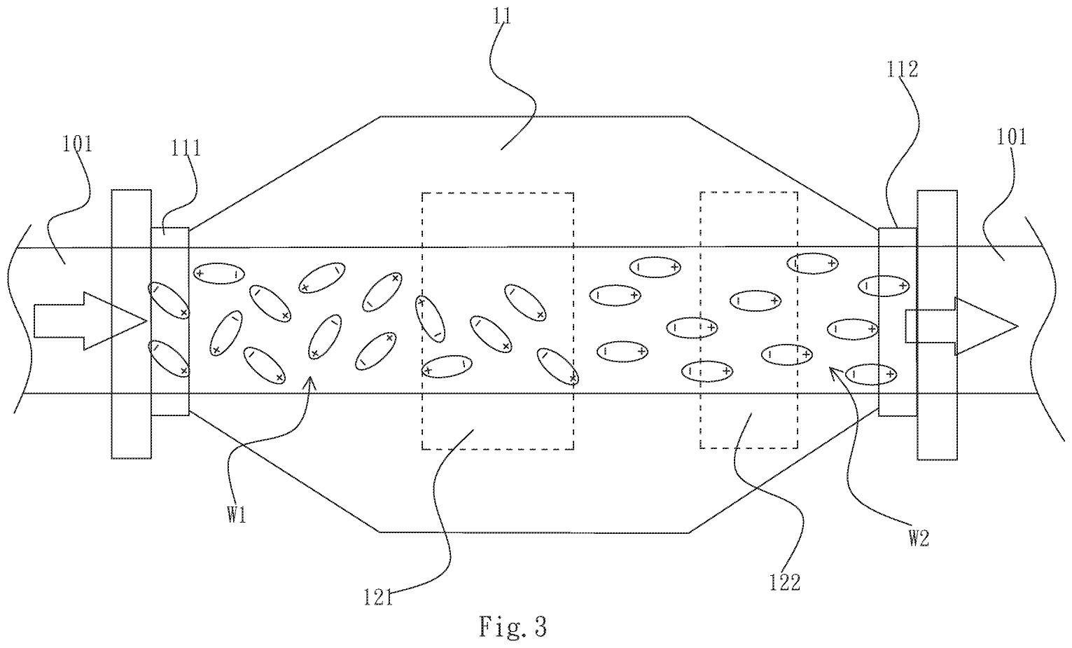

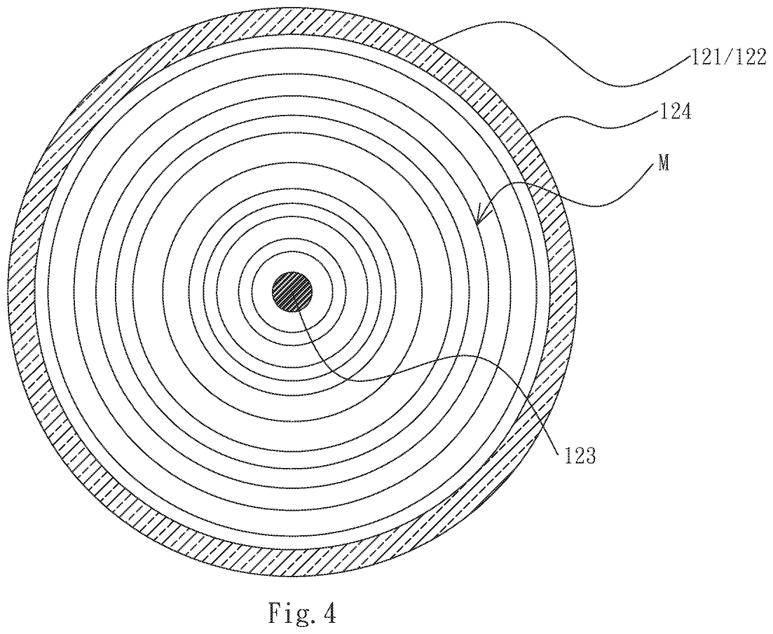

As shown in FIGS. 3 and 4, the multiple magnetization elements of the first sterilizer 11 and the second sterilizer 31 expand and retract electromagnetic fields and change directions of the magnetic fields so as to influence positive and negative charge of water molecules of the ballast water, and the electromagnetic fields drive free electrons to metal tubes of each of the first sterilizer 11 and the second sterilizer 31 from connection tubes of each of the first sterilizer 11 and the second sterilizer 31, wherein the metal tubes conduct electricity so as to push electrons to surround narrow sections of the metal tubes, and macromolecules are divided into micromolecules, then the micromolecules enter into the cell walls of the microorganism and the bacteria to sterilize the microorganism and the bacteria.

As illustrated in FIGS. 3 and 4, the multiple magnetization elements of each of the first sterilizer 11 and the second sterilizer 31 are electrified, for example the first sterilizer 11 has two electrified magnetization elements 121, 122, each of the two electrified magnetization elements 121/122 has a positive magnetic ring 123 so as to produce the electrons, and each electrified magnetization element 121/122 has a metal fence 124 surrounding an outer wall of each electrified magnetization element 121/122 so that after the positive magnetic ring 123 conducts the electricity, the metal tubes of the first sterilizer 11 produce the magnetic field M, inflow water W1 is converted into outflow water W2 having micromolecules, and the first sterilizer 11 has two connection segments 111, 112 connecting with the two connection tubes respectively so as to deliver the inflow water W1 and the outflow water W2 respectively.

With reference to FIG. 5, in another embodiment, the multiple magnetization elements of each of the first sterilizer 11 and the second sterilizer 31 are permanent-magnet, for example, the second sterilizer 31 has multiple permanent-magnet magnetization elements 13, each of the multiple permanent-magnet magnetization elements 13 is coupled with two first pipes 101, wherein each permanent-magnet magnetization element 13 has multiple magnetized rods 131 accommodated in each metal tube and has a support post 132 defined on a center of each permanent-magnet magnetization element 13 to fix the multiple magnetized rods 131, wherein the multiple magnetized rods 131 have spontaneous magnetization to magnetize and convert the inflow water W1 into the outflow water W2 having micromolecules, such that the outflow water W2 destroys the cell walls of the microorganism and the bacteria.

As illustrated in following list 2, a result of the device and the method of the present invention is shown after testing the device and the method for 120 hours according to the Section D-2 of the Ballast Water Management (BWM) Convention, wherein a control group and a test group are set in each predetermined testing time.

LIST 2

| | Total | | | | |
|---|---|---|---|---|---|
| | microorganism | | | May not | Not |
| | cATP_{bact(pg/100 mL)} | | Meeting | Meeting | Meeting |
| Sample | Control | Test | IMO | IMO | IMO |
| name | group | group | standard | standard | standard |
| background | 8.217 | 8.217 | <1.000 | 1.000-5.000 | >5.000 |
| after 24 hrs | 8.543 | 6.532 | | | |
| after 48 hrs | 8.253 | 2.653 | | | |
| after 72 hrs | 7.857 | 1.862 | | | |
| after 96 hrs | 7.589 | 1.232 | | | |
| after 120 hrs | 7.542 | 843 | | | |

Thereby, the device and the method of the present invention are capable of reducing a cost of silver ion or antimicrobial agents and destroying the cell walls of the microorganism and the bacteria in the ballast water.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A method of sterilizing ballast water comprising providing a device mounted in a pressurized cabin (C) of a ship (B), the device including: a first sterilization unit (10), multiple second sterilization units (20), and a third sterilization unit (30), wherein the first sterilizer (10) includes a first valve (Vi) connected with a first pump (P) via at least one first pipe (101), the first sterilizer (11) is connected with a first end of the first pump (P), and the at least one first pipe (101) is connected with a second end of the first pump (P), and the multiple second sterilization units (20) are accommodated in the pressurized cabin (C) and are soaked in ballast water (CW) of the pressurized cabin (C);
wherein a method of sterilizing the ballast water comprises steps of:
S1. feeding seawater (O), wherein the seawater (O) is fed into the first valve (Vi) from an exterior of the ship (B), and the first pump (P) pumps the seawater (O) into the first sterilizer (11) via the at least one first pipe (101);
S2. magnetizing, wherein the first sterilizer (11) has multiple magnetization elements so that after the seawater (O) flows into the first sterilizer (11), a magnetic field of the multiple magnetization elements destroy cell walls of microorganism and bacteria in the seawater (O), and the seawater (O) is fed into the pressurized cabin (C) so as to produce the ballast water (CW); and
S3. inhibiting a growth of the microorganism and the bacteria, wherein when the ballast water (CW) contacts with the multiple second sterilization units (20) of the pressurized cabin (C), the multiple second sterilization units (20) release silver ion or antimicrobial agents so as to inhibit a growth of the microorganism and the bacteria in the ballast water (CW), wherein an amount of the silver ion or the antimicrobial agents is reduced after the Step S2.

2. The method as claimed in claim 1, wherein the third sterilization unit (30) is mounted in a predetermined position of the ship (B) and includes a second pump (P) configured to pump the ballast water (CW) out of a second valve (Vo) from the pressurized cabin (C) via a second sterilizer (31) and a second pipe (301), wherein the second sterilizer (31) is connected with a first end of the second pump (P), and the second pipe (301) is connected with a second end of the second pump (P), wherein the second sterilizer (31) has multiple magnetization elements so as to produce a magnetic file to destroy the cell walls of rest microorganism and bacteria in the ballast water (CW), and the second pump (P) further pumps the ballast water (CW) out of the second valve (Vo) via the second pipe (301).

3. The method as claimed in claim 1, wherein the first sterilizer (11) has magnetization elements which are electrified or permanent-magnet.

4. The method as claimed in claim 2, wherein the second sterilizer (31) has magnetization elements which are electrified or permanent-magnet.

5. A device of sterilizing ballast water being mounted in a pressurized cabin (C) of a ship (B) and comprising:
a first sterilizer (10) including a first valve (Vi) configured to guide seawater (O) into the ship (B), a first pump (P) connected with the first valve (Vi) via at least one first pipe (101) and configured to pump the seawater (O) into a first sterilizer (11), wherein the first sterilizer (11) is connected with a first end of the first pump (P), and the at least one first pipe (101) is connected with a second end of the first pump (P), such that the seawater (O) flows into the pressurized cabin (C) to produce ballast water (CW);
multiple second sterilization units accommodated in the pressurized cabin (C) and soaked in ballast water (CW) of the pressurized cabin (C), wherein the multiple second sterilization units (20) release silver ion or antimicrobial agents so as to inhibit a growth of microorganism and bacteria in the ballast water (CW).

6. The device as claimed in claim 5 further comprising a sterilization unit (30) which is mounted in a predetermined position of the ship (B), wherein the sterilization unit (30) includes a second pump (P) configured to pump the ballast water (CW) out of a second valve (Vo) from the pressurized cabin (C) via a second sterilizer (31) and a second pipe (301), wherein the second sterilizer (31) is connected with a first end of the second pump (P), and the second pipe (301) is connected with a second end of the second pump (P), wherein the second sterilizer (31) has multiple magnetization elements so as to produce a magnetic file to destroy the cell walls of rest microorganism and bacteria in the ballast water (CW), and the second pump (P) further pumps the ballast water (CW) out of the second valve (Vo) via the second pipe (301).

7. The device as claimed in claim 5, wherein the first sterilizer (11) has magnetization elements which are electrified or permanent-magnet.

8. The device as claimed in claim 6, wherein the second sterilizer (31) has magnetization elements which are electrified or permanent-magnet.
